(19) United States
(12) Patent Application Publication
(10) Pub. No.: US 2023/0288144 A1
(43) Pub. Date: Sep. 14, 2023

(54) HEAT EXCHANGER

(71) Applicant: NGK Insulators, Ltd., Nagoya-City (JP)

(72) Inventors: Ryushiro AKAISHI, Nagoya-City (JP); Tatsuo KAWAGUCHI, Mizuho-City (JP)

(73) Assignee: NGK Insulators, Ltd., Nagoya-City (JP)

(21) Appl. No.: 18/162,768

(22) Filed: Feb. 1, 2023

(30) Foreign Application Priority Data
Mar. 10, 2022 (JP) 2022-037474

(51) Int. Cl. F28D 7/10; F28F 7/02

(52) U.S. Cl. CPC F28D 7/10; F28F 7/02; F28F 2265/00; F28F 2270/00

(57) ABSTRACT

A heat exchanger includes: a heat recovery member through which a first fluid can flow; an inner cylinder configured to house the heat recovery member; an outer cylinder having a feed port capable of feeding a second fluid and a discharge port capable of discharging the second fluid, the outer cylinder being disposed on a radially outer side of the inner cylinder with a distance such that a flow path for the second fluid is formed between the outer cylinder and the inner cylinder; a feed pipe connected to the feed port; and a discharge pipe connected to the discharge port.

### CROSS REFERENCE TO RELATED APPLICATIONS

The present invention claims the benefit of priority to Japanese Patent Application No 2022-037474 filed on Mar. 10, 2022 with the Japanese Patent Office, the entire contents of which are incorporated herein by reference in its entirety.

### FIELD OF THE INVENTION

The present invention relates to a heat exchanger.

### BACKGROUND OF THE INVENTION

Recently, there is a need for improvement of fuel economy of motor vehicles. In particular, a system is expected that worms up a coolant, engine oil and an automatic transmission fluid (ATF: Automatic Transmission Fluid) at an early stage to reduce friction losses, in order to prevent deterioration of fuel economy at the time when an engine is cold, such as when the engine is started. Further, a system is expected that heats an exhaust gas purifying catalyst in order to activate the catalyst at an early stage.

A such systems, for example, there is a heat exchanger. The heat exchanger is a device that exchanges heat between a first fluid and a second fluid by allowing the first fluid to flow inside and the second fluid to flow outside. In such a heat exchanger, for example, the heat can be effectively utilized by exchanging the heat from the first fluid having a higher temperature (for example, an exhaust gas) to the second fluid having a lower temperature (for example, cooling water).

Known as a heat exchanger for recovering heat from a high-temperature gas such as an exhaust gas from an automobile is a heat exchanger including: a hollow pillar shaped honeycomb structure having an inner peripheral wall, an outer peripheral wall, and partition walls disposed between the inner peripheral wall and the outer peripheral wall, the partition walls defining a plurality of cells, each of the cells extending from a first end face to a second end face to form a flow path for a first fluid; a first outer cylindrical member fitted to a surface of the outer peripheral wall of the pillar shaped honeycomb structure; an inner cylindrical member fitted to a surface of the inner peripheral wall of the pillar shaped honeycomb structure; an upstream cylindrical member having a portion disposed on a radial inward side of the inner cylindrical member with a distance so as to form the flow path for the first fluid; a cylindrical connecting member for connecting an upstream end portion of the first outer cylindrical member to an upstream side of the upstream cylindrical member so as to form the flow path for the first fluid; a downstream cylindrical member connected to a downstream end portion of the first outer cylindrical member, the downstream cylindrical member having a portion disposed on a radial outward side of the inner cylindrical member with a distance so as to form the flow path for the first fluid; a second outer cylindrical member disposed on a radial outward side of the first outer cylindrical member with a distance so as to form a flow path for a second fluid; and an on-off valve arranged on a downstream end portion side of the inner cylindrical member (Patent Literature 1). The heat exchanger having such a structure can switch between promotion of heat recovery from the first fluid to the second fluid and suppression of the heat recovery by opening and closing the on-off valve. Further, in this heat exchanger, the cylindrical member has a tapered portion whose diameter is decreased from the position of the second end face to the downstream end portion side of the pillar shaped honeycomb structure, and controls a ratio of a difference between the inner diameter of the downstream end portion of the inner cylindrical member and the inner diameter of the downstream end portion of the upstream cylindrical member within ±20%, or allows the downstream end portion of the upstream cylindrical member to extend to a downstream side of the position of the second end face of the pillar shaped honeycomb structure, whereby the backflow phenomenon of the first fluid can be suppressed during suppression of heat recovery, so that the heat shielding performance can be improved.

### PRIOR ART

### Patent Literature

[Patent Literature 1] WO 2021/171668 A1

### SUMMARY OF THE INVENTION

The present invention relates to a heat exchanger, comprising:
a heat recovery member through which a first fluid can flow;
an inner cylinder configured to house the heat recovery member;
an outer cylinder having a feed port capable of feeding a second fluid and a discharge port capable of discharging the second fluid, the outer cylinder being disposed on a radially outer side of the inner cylinder with a distance such that a flow path for the second fluid is formed between the outer cylinder and the inner cylinder;
a feed pipe connected to the feed port; and
a discharge pipe connected to the discharge port,
wherein, based on a flow path direction of the first fluid as a reference, the heat recovery member is arranged such that an axial central portion of the heat recovery member is located on a downstream side of an axial central portion of the inner cylinder, and a downstream end portion of the heat recovery member is located on an upstream side of a downstream end portion of the flow path for the second fluid.

### BRIEF DESCRIPTION OF THE DRAWINGS

FIG. 1 is a cross-sectional view of a heat exchanger according to Embodiment 1 of the present invention, which is parallel to a flow direction of a first fluid;

FIG. 2 is a cross-sectional view taken along the line a-a′ in the heat exchanger of FIG. 1;

FIG. 3 is a cross-sectional view of a honeycomb structure that can be used as a heat recovery member, which is perpendicular to an axial direction;

FIG. 4 is a cross-sectional view of a honeycomb structure that can be used as a heat recovery member, which is perpendicular to an axial direction;

FIG. 5 is a cross-sectional view of a heat exchanger according to Embodiment 2 of the present invention, which is parallel to a flow direction of a first fluid;

FIG. 6 is a cross-sectional view taken along line b-b′ in the heat exchanger of FIG. 5;

FIG. 7 is an enlarged cross-sectional view around one end portion of a flow path for a second fluid;

FIG. 8 is an enlarged cross-sectional view around one end portion of a flow path for a second fluid;

FIG. 9 is a cross-sectional view of a heat exchanger according to Embodiment 3 of the present invention, which is parallel to a flow direction of a first fluid;

FIG. 10 is a cross-sectional view of other heat exchanger according to Embodiment 3 of the present invention, which is parallel to a flow direction of a first fluid;

FIG. 11 is a cross-sectional view of a heat exchanger according to Embodiment 4 of the present invention, which is parallel to a flow direction of the first fluid;

FIG. 12 is a cross-sectional view of a heat exchanger according to Embodiment 5 of the present invention, which is parallel to a flow direction of a first fluid; and

FIG. 13 is a cross-sectional view of a heat exchanger according to Embodiment 6 of the present invention, which is parallel to a flow direction of a first fluid.

### DETAILED DESCRIPTION OF THE INVENTION

The heat exchanger of Patent Literature 1 described above does not particularly pay attention to the flow path for the second fluid, which is formed between the first outer cylindrical member and the second outer cylindrical member.

The present inventors have continued research to improve the heat recovery performance of heat exchangers, and found that there is a region where the second fluid stagnates in the flow path for the second fluid, and the boiling of the stagnating second fluid in the region deteriorates the heat recovery performance. Also, they have found that when the stagnating second fluid boils, the members forming the flow path for the second fluid around it tend to be eroded.

The present invention has been made to solve the above problems. An object of the present invention to provide a heat exchanger capable of improving heat recovery performance and suppressing the erosion of the members forming the flow path for the second fluid by suppressing the boiling of the second fluid.

As a result of intensive studies for heat exchangers having various structures, the present inventors have found that the above problems can be solved by controlling the position of the heat recovery member, and have completed the present invention.

The present invention relates to a heat exchanger, including: a heat recovery member through which a first fluid can flow; an inner cylinder configured to house the heat recovery member; an outer cylinder having a feed port capable of feeding a second fluid and a discharge port capable of discharging the second fluid, the outer cylinder being disposed on a radially outer side of the inner cylinder with a distance such that a flow path for the second fluid is formed between the outer cylinder and the inner cylinder; a feed pipe connected to the feed port; and a discharge pipe connected to the discharge port, wherein, based on a flow path direction of the first fluid as a reference, the heat recovery member is arranged such that an axial central portion of the heat recovery member is located on a downstream side of an axial central portion of the inner cylinder, and a downstream end portion of the heat recovery member is on an upstream side of a downstream end portion of the flow path for the second fluid. This heat exchanger may be provided with a boiling suppressing portion for suppressing the boiling of the second fluid in the flow path for the second fluid.

According to the present invention, it is possible to provide a heat exchanger capable of improving heat recovery performance and suppressing the erosion of the members forming the flow path for the second fluid.

Hereinafter, embodiments of the heat exchangers according to the present invention will be specifically described with reference to the drawings. It is to understand that the present invention is not limited to the following embodiments, and those which appropriately added changes, improvements and the like to the following embodiments based on knowledge of a person skilled in the art without departing from the spirit of the present invention fall within the scope of the present invention.

### Embodiment 1

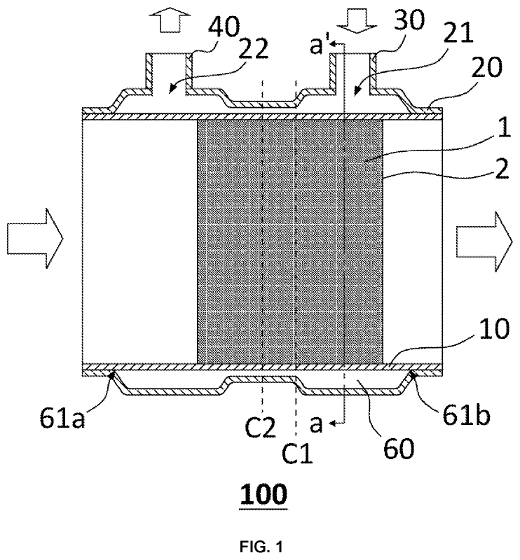

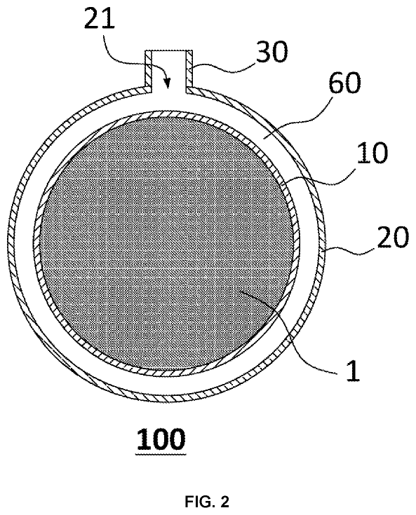

FIG. 1 is a cross-sectional view of a heat exchanger according to Embodiment 1 of the present invention, which is parallel to a flow direction of a first fluid. Also, FIG. 2 is a cross-sectional view taken along the line a-a′ in the heat exchanger of FIG. 1.

As shown in FIGS. 1 and 2, a heat exchanger 100 according to Embodiment 1 of the present invention includes: a heat recovery member 1; an inner cylinder 10; an outer cylinder 20; a feed pipe 30; and a discharge pipe 40.

### <Heat Recovery Member 1>

The heat recovery member 1 is a member through which the first fluid can flow. The heat recovery member 1 has a function of recovering the heat of the first fluid when the first fluid flows. The heat recovery member 1 is housed inside the inner cylinder 10.

The flow of the second fluid may be slow down around an axial end portion of a flow path 60 for a second fluid (around an upstream end portion 61a of the flow path 60 for the second fluid, especially when the flow path direction of the first fluid is used as a reference), although it depends on the shape of the flow path 60 for the second fluid. In this case, the second fluid tends to stagnate around the axial end portion of the flow path 60 for the second fluid, and the temperature of the second fluid may continuously increase, causing the second fluid to boil. In such a state, the heat recovery performance is deteriorated, and the members around it (the inner cylinder 10 and the outer cylinder 20) tend to be eroded.

Therefore, the heat recovery member 1 is arranged such that an axial central portion C1 of the heat recovery member 1 is located on a downstream side of an axial central portion C2 of the inner cylinder 10, and the downstream end portion 2 of the heat recovery member 1 is on an upstream side of a downstream end portion 61b of the flow path 60 for the second fluid, based on the flow path direction of the first fluid as a reference. By arranging the heat recovery member 1 at such a position, the flow path for the first fluid before entering the heat recovery member 1 is widened. As a result, the flow rate of the first fluid decreases and the heat transfer coefficient decreases at that portion, so that it is possible to suppress the heat of the first fluid from being transmitted to the second flow path via the inner cylinder 10. Further, since a distance between the upstream end portion 61a of the flow path 60 for the second fluid and the heat recovery member 1 is also increased, heat input due to the heat recovery member 1 can be suppressed around the upstream end portion 61a of the flow path 60 for the second fluid, so that the temperature of the second fluid can be decreased. As a result, the boiling of the second fluid around the upstream end portion 61a of the flow path 60 for the second fluid can be suppressed.

The downstream end portion 2 of the heat recovery member 1 is preferably arranged on the upstream side by 10 mm or more away from the downstream end portion 61b of the flow path 60 for second fluid, based on the flow path direction of the first fluid as a reference. By arranging the downstream end portion 2 of the heat recovery member 1 at such a position, the above effects can be stably enhanced.

The downstream end portion 2 of the heat recovery member 1 is preferably arranged on an upstream side away from the downstream end portion 61b of the flow path 60 for the second fluid by 10% or more of the length of the flow path 60 for second fluid, based on the flow path direction of the first fluid as a reference. By arranging the downstream end portion 2 of the heat recovery member 1 at such a position, the above effects can be stably enhanced.

The length (axial length) of the heat recovery member 1 is preferably 20 to 90% of the length of the flow path 60 for the second fluid, based on the flow path direction of the first fluid as a reference. By thus controlling the length of the heat recovery member 1, the above effects can be stably enhanced.

Although the heat recovery member 1 is not particularly limited, it is preferably a honeycomb structure.

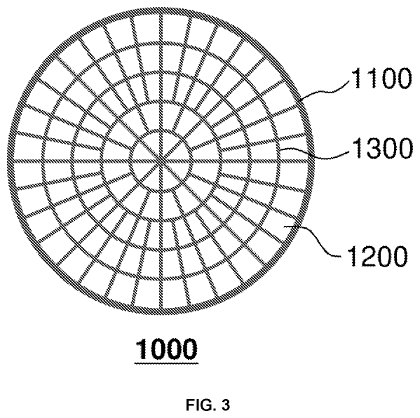

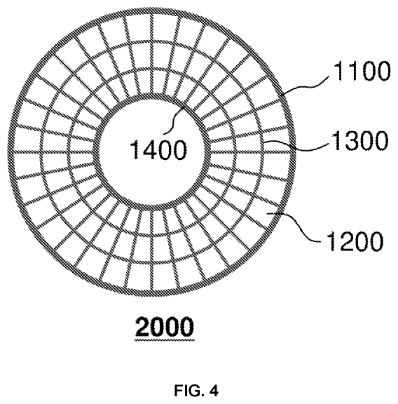

Here, each of FIGS. 3 and 4 illustrates a cross sectional view of a honeycomb structure that can be used as the heat recovery member 1, which is perpendicular to an axial direction (flow path direction of the first fluid).

A honeycomb structure 1000 shown in FIG. 3 includes: an outer peripheral wall 1100; and a plurality of partition walls 1300 disposed on an inner side of the outer peripheral wall 1100, the partition walls 1300 defining plurality of cells 1200 extending from a first end face to a second end face to form flow paths for the first fluid. Moreover, a honeycomb structure 2000 shown in FIG. 4 includes: an outer peripheral wall 1100; an inner peripheral wall 1400; and a partition wall 1300 disposed between the outer peripheral wall 1100 and the inner peripheral wall 1400, the partition wall 1300 defining a plurality of cells 1200 extending from a first end face to a second end face to form flow paths for the first fluid.

A shape (an outer shape) of the honeycomb structure 1000, 2000 may be set depending on the shape of the inner cylinder, and is not particularly limited. Examples of the shape (outer shape) of the honeycomb structure 1000, 2000 include a cylindrical shape, an elliptic pillar shape, a quadrangular pillar shape or other polygonal pillar shape. Although a shape of a hollow portion (an inner region of the inner peripheral surface 1400) in the honeycomb structure 2000 may be, but not limited to, the same as or different from the outer shape of the honeycomb structure 200, it is preferable that they are the same as each other, in terms of resistance against external impact, thermal stress and the like.

Each of the outer peripheral wall 1100 and the inner peripheral wall 1400 has a thickness larger than that of the partition wall 1300. Such a structure can lead to increased strengths of the outer peripheral wall 1100 and the inner peripheral wall 1400 which would otherwise tend to generate breakage (e.g., cracking, chinking, and the like) due to external impact, thermal stress caused by a temperature difference between the first fluid and the second fluid, and the like.

The thicknesses of the outer peripheral wall 1100, the partition walls 1300 and the inner peripheral wall 1400 may be appropriately adjusted according to applications and the like. For example, the thickness of each of the outer peripheral wall 1100 and the inner peripheral wall 1400 is preferably more than 0.3 mm and 10 mm or less when using the heat exchanger 100 for general heat exchange applications, and more preferably from 0.5 mm to 5 mm, and even more preferably from 1 mm to 3 mm. Moreover, when using the heat exchanger 100 for a thermal storage application, the thickness of the outer peripheral wall 1100 is preferably 10 mm or more, in order to increase a heat capacity of the outer peripheral wall 1100.

The thickness of the partition wall 1300 may preferably be from 0.1 to 1 mm, and more preferably from 0.2 to 0.6 mm. The thickness of the partition wall 1300 of 0.1 mm or more can provide the honeycomb structure 1000, 2000 with a sufficient mechanical strength. Further, the thickness of the partition wall 1300 of 1 mm or less can prevent problems that the pressure loss is increased due to a decrease in an opening area and the heat recovery efficiency is decreased due to a decrease in a contact area with the first fluid.

The outer peripheral wall 1100, the partition walls 1300 and the inner peripheral wall 1400 are based on ceramics. The phrase “based on ceramics” means that a ratio of a mass of ceramics to the total mass is 50% by mass or more.

Each of the outer peripheral wall 1100, the partition walls 1300 and the inner peripheral wall 1400 preferably has a porosity of 10% or less, and more preferably 5% or less, and even more preferably 3% or less. Further, the porosity of these may be 0%. The porosity of these of 10% or less can lead to improvement of thermal conductivity.

The outer peripheral wall 1100, the partition wall 1300 and the inner peripheral wall 1400 are preferably based on SiC (silicon carbide) having high thermal conductivity. The phrase “based on SiC (silicon carbide)” means that a ratio of a mass of SiC (silicon carbide) to the total mass is 50% by mass or more.

More particularly, the material of each of the outer peripheral wall 1100, the partition wall 1300 and the inner peripheral wall 1400 that can be used herein includes Si-impregnated SiC, (Si+Al)-impregnated SiC, metal composite SiC, recrystallized SiC, Si₃N₄, SiC, and the like. Among them, Si-impregnated SiC and (Si+Al)-impregnated SiC are preferred because they can be manufactured at lower costs and have high thermal conductivity.

A cell density (that is, the number of cells 1200 per unit area) in the cross section of the honeycomb structure 1000, 2000 perpendicular to the flow path direction of the first fluid is not particularly limited, and it may be adjusted as needed depending on the applications. The cell density may preferably be in a range of from 4 to 320 cells/cm². The cell density of 4 cells/cm² or more can sufficiently ensure the strength of the partition walls 1300, hence the strength of the honeycomb structure 1000, 2000 itself and effective GSA (geometrical surface area). Further, the cell density of 320 cells/cm² or less can allow an increase in a pressure loss to be prevented when the first fluid flows.

The honeycomb structure 1000, 2000 preferably has an isostatic strength of more than 100 MPa or more, and more preferably 200 MPa or more. The isostatic strength of the honeycomb structure 1000, 2000 of more than 100 MPa can lead to the honeycomb structure 1000, 2000 having improved durability. The isostatic strength of the honeycomb structure 1000, 2000 can be measured according to the method for measuring isostatic fracture strength as defied in the JASO standard M 505-87 which is a motor vehicle standard issued by Society of Automotive Engineers of Japan, Inc.

A diameter (outer diameter) of the outer peripheral wall 1100 in the cross section orthogonal to the flow path direction of the first fluid may preferably be from 20 to 200 mm, and more preferably from 30 to 100 mm. Such a diameter can allow improvement of heat recovery efficiency. If the outer peripheral wall 1100 is not circular, the diameter of the largest inscribed circle inscribed in the cross-sectional shape of the outer peripheral wall 1100 is defined as the diameter of the outer peripheral wall 1100.

Further, in the case of the honeycomb structure 2000, a diameter of the inner peripheral wall 1400 in the cross section orthogonal to the flow path direction of the first fluid is preferably from 1 to 60 mm, and more preferably from 2 to 30 mm. If the cross-sectional shape of the inner peripheral wall 1400 is not circular, the diameter of the largest inscribed circle inscribed in the cross-sectional shape of the inner peripheral wall 1400 is defined as the diameter of the inner peripheral wall 1400.

The honeycomb structure 1000, 2000 preferably has a thermal conductivity of 50 W/(mK) or more at 25° C., and more preferably from 100 to 300 W/(mK), and even more preferably from 120 to 300 W/(m K). The thermal conductivity of the honeycomb structure 1000, 2000 in such a range can lead to an improved thermal conductivity and can allow the heat inside the honeycomb structure 1000, 2000 to be efficiently transmitted to the outside. It should be noted that the value of thermal conductivity is a value measured according to the laser flash method (JIS R 1611-1997).

In the case where an exhaust gas as the first fluid flows through the cells 1200 in the honeycomb structure 1000, 2000, a catalyst may preferably be supported on the partition wall 1300 of the honeycomb structure 10. The supporting of the catalyst on the partition wall 13 can allow CO, NOx, HC and the like in the exhaust gas to be converted into harmless substances through catalytic reaction, and can also allow reaction heat generated during the catalytic reaction to be utilized for heat exchange. Preferable catalysts include those containing at least one element selected from the group consisting of noble metals (platinum, rhodium, palladium, ruthenium, indium, silver and gold), aluminum, nickel, zirconium, titanium, cerium, cobalt, manganese, zinc, copper, tin, iron, niobium, magnesium, lanthanum, samarium, bismuth, and barium. Any of the above-listed elements may be contained as a metal simple substance, a metal oxide, or other metal compound.

### <Inner Cylinder 10>

The inner cylinder 10 is a member configured to house the heat recovery member 1. The inner cylinder 10 is fitted to an outer peripheral surface of the heat recovery member 1 parallel to the flow direction of the first fluid.

As used herein, the “fitted” means that the heat recovery member 1 and the inner cylinder 10 are fixed in a state of being suited to each other. Therefore, the fitting of the heat recovery member 1 and the inner cylinder 10 encompasses cases where the heat recovery member 1 and the inner cylinder 10 are fixed to each other by a fixing method based on fitting such as clearance fitting, interference fitting and shrinkage fitting, as well as by brazing, welding, diffusion bonding, or the like.

The shape of the inner cylinder 10 is not particularly limited, and it may be various cylindrical shapes such as a cylindrical shape and a rectangular cylindrical shape.

It is preferable that an axial direction of the inner cylinder 10 coincides with that of the heat recovery member 1, and a central axis of the inner cylinder 10 coincides with that of the heat recovery member 1. Further, diameters (an outer diameter and an inner diameter) of the inner cylinder 10 may be uniform in the axial direction, but the diameter of at least a part (for example, both end portions in the axial direction or the like) of the inner cylinder may be decreased or increased.

It should be noted that when the inner cylinder 10 is not cylindrical, the outer diameter and inner diameter of the inner cylinder 10 mean the diameters of the maximum circles that circumscribe and inscribe the cross-sectional shape of the inner cylinder 10 perpendicular to the flow direction of the first fluid.

The inner cylinder 10 may preferably have an inner peripheral surface shape corresponding to the outer peripheral surface of the heat recovery member 1 parallel to the flow direction of the first fluid. Since the inner peripheral surface of the inner cylinder 10 is in direct contact with the surface of the outer peripheral surface of the heat recovery member 1, the thermal conductivity is improved and the heat in the heat recovery member 1 can be efficiently transmitted to the inner cylinder 10.

In terms of improvement of the heat recovery efficiency, a higher ratio of an area of a portion circumferentially covered with the inner cylinder 10 in the outer peripheral surface of the heat recovery member 1 to the total area of the outer peripheral surface of the heat recovery member 1 is preferable. Specifically, the area ratio is preferably 80% or more, and more preferably 90% or more, and even more preferably 100% (that is, the entire outer peripheral surface of the heat recovery member 1 is circumferentially covered with the inner cylinder 10).

The inner cylinder 10 is preferably made of a metal in terms of manufacturability, although not particularly limited thereto. Further, the metallic inner cylinder 10 is also preferable in that it can be easily welded to an outer cylinder 20 or the like. Examples of the material of the inner cylinder 10 that can be used herein include stainless steel, titanium alloys, copper alloys, aluminum alloys, brass and the like. Among them, the stainless steel is preferable because it has high durability and reliability and is inexpensive.

The inner cylinder 10 preferably has a thickness of 0.1 mm or more, and more preferably 0.3 mm or more, and still more preferably 0.5 mm or more, although not particularly limited thereto. The thickness of the inner cylinder 10 of 0.1 mm or more can ensure durability and reliability. The thickness of the inner cylinder 10 is preferably 10 mm or less, and more preferably 5 mm or less, and still more preferably 3 mm or less. The thickness of the inner cylinder 10 of 10 mm or less can reduce thermal resistance and improve thermal conductivity.

### <Outer Cylinder>

The outer cylinder 20 has a feed port 21 capable of feeding the second fluid and a discharge port 22 capable of discharging the second fluid. Also, the outer cylinder 20 is arranged on a radially outer side of the inner cylinder 10 with a distance such that a flow path 60 for a second fluid is formed between the outer cylinder 20 and the inner cylinder 10.

It is preferable that an axial direction of the outer cylinder 20 coincides with that of the inner cylinder 10, and a central axis of the outer cylinder 20 coincides with that of the inner cylinder 10.

The outer cylinder 20 is preferably arranged such that inner peripheral surfaces on an upstream end portion side and a downstream end portion side are in direct or indirect contact with the outer peripheral surface of the inner cylinder 10.

A method of fixing the inner peripheral surfaces on the upstream end portion side and the downstream end portion side to the outer peripheral surface of the inner cylinder 10 that can be used includes, but not limited to, fitting such as clearance fitting, interference fitting and shrinkage fitting, as well as brazing, welding, diffusion bonding, and the like.

The shape of the outer cylinder 20 is not particularly limited, and it may be various cylindrical shapes such as a cylindrical shape and a rectangular cylindrical shape.

Diameters (outer diameter and inner diameter) of the outer cylinder 20 may be uniform in the axial direction, but the diameter of at least a part (for example, an axial central portion, both axial end portions, or the like) of the outer cylinder 20 may be decreased or increased. For example, by decreasing the diameter of the axial central portion of the outer cylinder 20, the second fluid can spread throughout the outer peripheral direction of the inner cylinder 10 in the outer cylinder 20 on the feed port 21 and discharge port 22 sides. Therefore, an amount of the second fluid that does not contribute to the heat exchange at the axial central portion is reduced, so that the heat exchange efficiency can be improved.

It should be noted that when the outer cylinder 20 is not cylindrical, the outer diameter and inner diameter of the outer cylinder 20 mean the diameters of the maximum circles that circumscribe and inscribe the cross-sectional shape of the outer cylinder 20 perpendicular to the flow direction of the first fluid.

A material of the outer cylinder 20 is not particularly limited, and it may be the same as that of the inner cylinder 10 as described above.

A thickness of the outer cylinder 20 is not particularly limited and it may be the same as that of the inner cylinder 10 as described above.

### <Feed Pipe 30 and Discharge Pipe 40>

The feed pipe 30 is connected to the feed port 21 of the outer cylinder 20, and the discharge pipe 40 is connected to the discharge port 22 of the outer cylinder 20. By thus connecting the feed pipe 30 to the discharge pipe 40, the second fluid can be fed and discharged between the inner cylinder 10 and the outer cylinder 20.

The feed pipe 30 and the discharge pipe 40 may extend in the same direction or may extend in different directions.

In the heat exchanger 100 according to Embodiment 1 of the present invention, the heat recovery member 1 is arranged such that the axial central portion C1 of the heat recovery member 1 is located on the downstream side of the axial central portion C2 of the inner cylinder 10 and the downstream end portion 2 of the heat recovery member 1 is located on the upstream side of the downstream end portion 61b of the flow path 60 for the second fluid, based on the flow path direction of the first fluid as a reference. Therefore, the heat recovery performance can be improved, and the melting damage (erosion) of the members that form the flow path 60 for the second fluid can be suppressed.

### Embodiment 2

A heat exchanger according to Embodiment 2 of the present invention is different from the heat exchanger 100 according to Embodiment 1 of the present invention in that the former includes a flow path blocking member 50 as a boiling suppressing portion in the flow path for the second fluid.

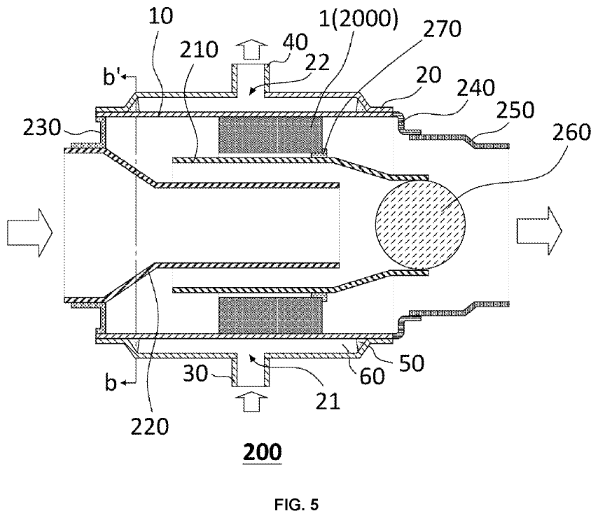

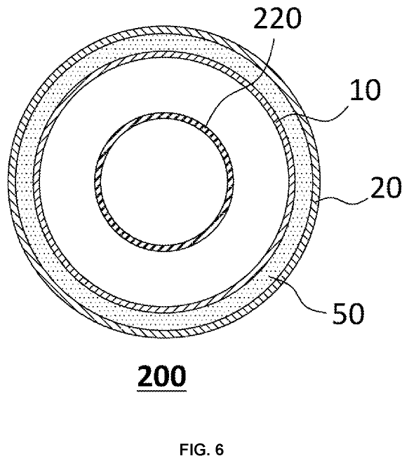

FIG. 5 is a cross-sectional view of a heat exchanger according to Embodiment 2 of the present invention, which is parallel to a flow direction of a first fluid. Also, FIG. 6 is a cross-sectional view taken along line b-b′ in the heat exchanger of FIG. 5. It should be noted that FIG. 5 shows a case where the hollow honeycomb structure 2000 is used as the heat recovery member 1, as an example.

As shown in FIGS. 5 and 6, a heat exchanger 200 according to Embodiment 2 of the present invention includes: an inner cylinder 10; an outer cylinder 20; a feed pipe 30; a discharge pipe 40; and a flow path blocking member 50 as a boiling suppressing portion. Further, the heat exchanger 200 according to Embodiment 2 of the present invention further includes: a first cylindrical member 210; a second cylindrical member 220; a first cylindrical connecting member 230; a second cylindrical connecting member 240; a third cylindrical member 250; and an on-off valve 260.

It should be noted that the components having the same reference numerals as those appearing in the description of the heat exchanger 100 according to Embodiment 1 of the present invention are the same as those of the heat exchanger 200 according to Embodiment 2 of the present invention. Therefore, the descriptions thereof are omitted.

### <Flow Path Blocking Member 50>

The flow path blocking member 50 is a boiling suppressing portion that suppresses the boiling of the second fluid. The flow path blocking member 50 is arranged to block at least part of the flow path 60 for the second fluid.

As described in Embodiment 1, the flow of the second fluid may slow down around the axial end portions of the flow path 60 for the second fluid, although it depends on the shape of the flow path 60 for the second fluid. In this case, the second fluid tends to stagnate around the axial end portions of the flow path 60 for the second fluid, and the temperature of the second fluid may continuously increase, causing the second fluid to boil. In such a state, the heat recovery performance is deteriorated, and the members around it (the inner cylinder 10 and the outer cylinder 20) tend to be eroded.

The flow path blocking member 50 is arranged at a portion where the second fluid tends to stagnate and boil. Therefore, the flow path blocking member 50 is preferably arranged to block at least one end portion of the flow path 60 for the second fluid, and is more preferably arranged to block both end portions of the flow path 60 for the second fluid.

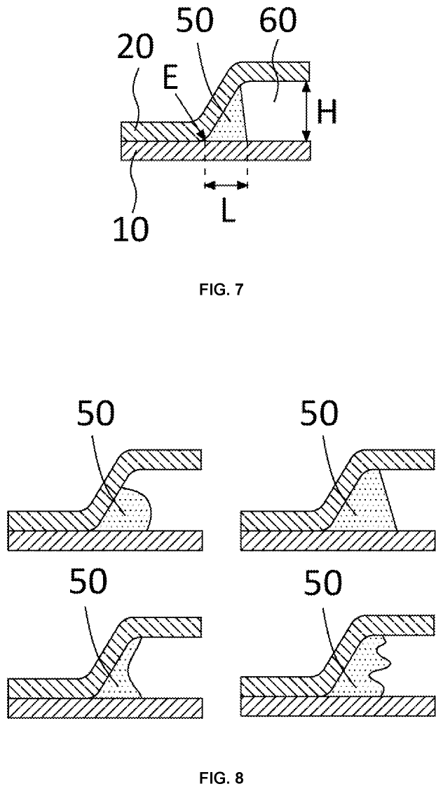

Here, FIG. 7 shows an enlarged cross-sectional view around one end portion of the flow path 60 for the second fluid. When the flow path blocking member 50 is arranged at the end portion of the flow path 60 for the second fluid, it is preferable to block a region from a flow path end portion E for the second fluid to a length region L of 50% or less of the maximum flow path height H of the flow path 60 for the second fluid. By blocking such a region with the flow path blocking member 50, the second fluid is difficult to stagnate, so that the boiling of the second fluid can be stably suppressed. When a length region of more than 50% of the maximum flow path height H of the flow path 60 for the second fluid from the flow path end portion E for the second fluid is blocked, the flow path 60 for the second fluid is excessively decreased, so that the heat recovery performance may be deteriorated.

The flow path blocking member 50 is preferably a ring-shaped member. By using the flow path blocking member 50 as the ring-shaped member, the flow path blocking member 50 can be easily arranged at a predetermined position in the flow path 60 for the second fluid. The ring-shaped member may be fixed by welding or an adhesive, for example, after two halved parts are arranged at predetermined positions in the flow path 60 for the second fluid to form one ring-shaped member.

The shape of the flow path blocking member 50 is not particularly limited as long as it is a shape that can block a predetermined region. For example, in the cross section parallel to the flow direction of the first fluid, the shape of the flow path blocking member 50 is a fan shape (upper left view), a trapezoid (upper right view), a chamfered shape (lower left view), and an irregular shape (lower right view) as shown in FIG. 8. It should be noted that FIG. 8 is an enlarged cross-sectional view around one end portion of the flow path 60 for the second fluid, as with FIG. 7.

The material of the flow path blocking member 50 is not particularly limited as long as it is not dissolved in the second fluid and has a melting point higher than the boiling point of the second fluid. For example, if the second fluid is water, the material of the flow path blocking member 50 may be a material that is water-insoluble and has a melting point higher than 100° C. Examples of the material for the flow path blocking member 50 that can be used herein include metals and thermosetting resins, more particularly, stainless steel, titanium alloys, copper alloys, aluminum alloys, brass, phenolic resins, urea resins, melamine resins, epoxy resins, non-saturated polyester resins, alkyd resins, polyimide resins, polyurethane resins, allyl resins, diallyl phthalate resins, silicone resins and the like.

### <First Cylindrical Member 210>

The first cylindrical member 210 is fitted to the inner peripheral wall 1400 of the honeycomb structure 2000. The fitting method is not particularly limited, and the same fitting method as described above may be used.

The first cylindrical member 210 is a cylindrical member having an upstream end portion and a downstream end portion and having a part of the outer peripheral surface fitted to the inner peripheral wall 1400 of the honeycomb structure 2000. The part of the outer peripheral surface of the first cylindrical member 210 and the inner peripheral wall 1400 of the honeycomb structure 2000 may be in indirect contact with each other or may be in indirect contact via a sealing material 270 (e.g., a mat material, a mesh material, a ring member, etc.).

Preferably, an axial direction of the first cylindrical member 210 coincides with that of the honeycomb structure 2000, and a central axis of the first cylindrical member 210 coincides with that of the honeycomb structure 2000.

The material of the first cylindrical member 210 is not particularly limited, and the same material as that of the inner cylinder 10 may be used.

The thickness of the first cylindrical member 210 is not particularly limited, and it may be the same thickness as that of the inner cylinder 10 as described above.

The first cylindrical member 210 preferably has a tapered portion whose diameter is decreased from the position corresponding to the second end face of the honeycomb structure 2000 to the downstream end portion side. The providing of such a tapered portion can reduce a difference between the inner diameter of the downstream end portion of the first cylindrical member 210 and the inner diameter of the downstream end portion of the second cylindrical member 220. In this case, when heat recovery is suppressed (when the on-off valve 260 is opened), it can achieve the equivalent flow rate of the first fluid in the vicinity of the downstream end portion of the second cylindrical member 220 to that of the first fluid in the vicinity of the downstream end portion of the first cylindrical member 210, thus decreasing a difference between pressures in the vicinity of the downstream end portion of the second cylindrical member 220 and in the vicinity of the downstream end portion of the first cylindrical member 210. As a result, the backward flow phenomenon of the first fluid flowing through the space between the first cylindrical member 210 and the second cylindrical member 220 to the honeycomb structure 2000 can be suppressed, so that the heat insulation performance can be improved.

### <Second Cylindrical Member 220>

The second cylindrical member 220 has a portion arranged on a radial inner side of the first cylindrical member 210 with a distance so as to form the flow path for the first fluid.

The second cylindrical member 220 is a cylindrical member having an upstream end portion and a downstream end portion.

It is preferable that an axial direction of the second cylindrical member 220 coincides with that of the honeycomb structure 2000, and a central axis of the second cylindrical member 220 coincides with that of the honeycomb structure 2000.

The structure of the second cylindrical member 220 on the upstream end portion side is not particularly limited, and it may be adjusted as needed depending on the shapes of other components (for example, piping) to which the upstream end portion of the second cylindrical member 220 is connected. For example, if the diameter of the other component is larger than that of the upstream end portion, the diameter on the upstream end portion side can be increased.

A method for fixing the second cylindrical member 220 is not particularly limited, but for example, it may be fixed to the inner cylinder 10 or the like via a first cylindrical connecting member 230 as described below. The fixing method includes, but not particularly limited to, the same method as the fixing method of the inner cylinder 10 as described above.

The material of the second cylindrical member 220 is not particularly limited, and the same material as that of the inner cylinder 10 may be used.

The thickness of the second cylindrical member 220 is not particularly limited, and it may be the same thickness as that of the inner cylinder 10 as described above.

### <First Cylindrical Connecting Member 230>

The first cylindrical connecting member 230 is a cylindrical member that connects the upstream end portion of the inner cylinder 10 to the upstream side of the second cylindrical member 220 so as to form the flow path for the first fluid. The connection may be direct or indirect. In the case of indirect connection, for example, an upstream end portion of the outer cylinder 20 or the like may be arranged between the upstream end portion of the inner cylinder 10 and the upstream side of the second cylindrical member 220.

It is preferable that an axial direction of the first cylindrical connecting member 230 coincides with that of the honeycomb structure 2000, and a central axis of the first cylindrical connecting member 230 coincides with that of the honeycomb structure 2000.

The material of the first cylindrical connecting member 230 is not particularly limited, and the same material as that of the inner cylinder 10 may be used.

The thickness of the first cylindrical connecting member 230 is not particularly limited, and it may be the same thickness as that of the inner cylinder 10 as described above.

### <Second Cylindrical Connecting Member 240>

The second cylindrical connecting member 240 is a cylindrical member that connects the downstream end portion of the inner cylinder 10 to the upstream side of the third cylindrical member 250. The connection may be direct or indirect. In the case of indirect connection, for example, a downstream end portion of the outer cylinder 20 or the like may be arranged between the downstream end portion of the inner cylinder 10 and the upstream side of the third cylindrical member 250.

It is preferable that an axial direction of the second cylindrical connecting member 240 coincides with that of the honeycomb structure 2000, and a central axis of the second cylindrical connecting member 240 coincides with that of the honeycomb structure 2000.

The material of the second cylindrical connecting member 240 is not particularly limited, and the same material as that of the inner cylinder 10 may be used.

The thickness of the second cylindrical connecting member 240 is not particularly limited, and it may be the same thickness as that of the inner cylinder 10 as described above.

### <Third Cylindrical Member 250>

The third cylindrical member 250 is a member connected to the downstream side of the second cylindrical connecting member 240.

It is preferable that an axial direction of the third cylindrical member 250 coincides with that of the honeycomb structure 2000, and a central axis of the third cylindrical member 250 coincides with that of the honeycomb structure 2000.

The structure of the third cylindrical member 250 on the downstream end portion is not particularly limited, and it may be adjusted as needed depending on the shapes of other components (for example, piping) to which the downstream end portion of the third cylindrical member 250 is connected. For example, if the diameter of the other component is smaller than that of the downstream end portion, the diameter on the downstream end portion can be decreased.

The material of the third cylindrical member 250 is not particularly limited, and the same material as that of the inner cylinder 10 may be used.

The thickness of the third cylindrical member 250 is not particularly limited, and it may be the same thickness as that of the inner cylinder 10 as described above.

### <On-Off Valve 260>

The on-off valve 560 is arranged on the downstream end portion side of the first inner cylindrical member 210. Although an arrangement method of the on-off valve 260 is not particularly limited, the on-off valve 260 can be fixed to a shaft (now shown) that is rotatably supported by a bearing arranged on a radially outer side of the third cylindrical connecting member 250, and arranged so as to penetrate the third cylindrical member 250 and the first inner cylindrical member 210.

The shape of the on-off valve 260 is not particularly limited, and an appropriate shape may be selected depending on the shape of the first cylindrical member 210 in which the on-off valve 260 is arranged.

The valve on-off valve 260 can be opened and closed by driving (rotating) the shaft by an actuator (not shown). That is, the on-off valve 260 can be opened and closed by rotating the on-off valve 260 together with the shaft.

The on-off valve 260 is configured so that the flow of the first fluid inside the first inner cylindrical member 210 can be controlled. More particularly, by closing the on-off valve 260 during promotion of heat recovery, the first fluid can flow through the space between the first cylindrical member 210 and the second cylindrical member 220 to the honeycomb structure 2000. Further, by opening the on-off valve 260 during suppression of heat recovery, the first fluid can be circulated from the downstream end portion side of the first inner cylindrical member 210 to the third cylindrical member 250 to discharge the first fluid to the outside of the heat exchanger 200.

Since the heat exchanger 200 according to Embodiment 2 of the present invention includes the flow path blocking member 50 as the boiling suppressing portion in the flow path 60 for the second fluid, effects of improving the heat recovery performance and of suppressing the erosion of the members forming the flow path 60 can be enhanced.

### Embodiment 3

A heat exchanger according to Embodiment 3 of the present invention is different from the heat exchanger 100 according to Embodiment 1 of the present invention in that the former includes a flow path blockage-processed portion as a boiling suppressing portion in at least a part of the outer cylinder 20.

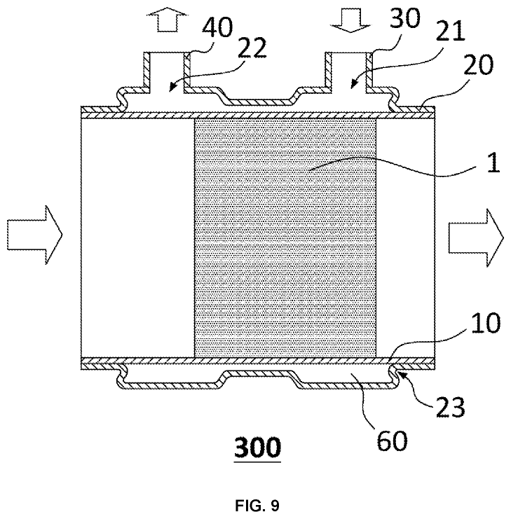

FIG. 9 is a cross-sectional view of a heat exchanger according to Embodiment 3 of the present invention, which is parallel to the flow direction of the first fluid.

As shown in FIG. 9, a heat exchanger 300 according to Embodiment 3 of the present invention includes: an inner cylinder 10; an outer cylinder 20; a feed pipe 30; and a discharge pipe 40. Moreover, the heat exchanger 300 has a folded structure 23 formed on at least one end portion side of the outer cylinder 20 as a flow path blockage-processed portion.

It should be noted that the components having the same reference numerals as those appearing in the description of the heat exchanger 100 according to Embodiment 1 of the present invention are the same as those of the heat exchanger 300 according to Embodiment 3 of the present invention. Therefore, the descriptions thereof are omitted.

As described in Embodiment 1, the flow of the second fluid may slow down around the axial end portions of the flow path 60 for the second fluid, although it depends on the shape of the flow path 60 for the second fluid. In this case, the second fluid tends to stagnate around the axial end portions of the flow path 60 for the second fluid, and the temperature of the second fluid may continuously increase, causing the second fluid to boil. In such a state, the heat recovery performance is deteriorated, and the members around it (the inner cylinder 10 and the outer cylinder 20) tend to be eroded.

Therefore, in the heat exchanger 300 according to Embodiment 3 of the present invention, the folded structure 23 is formed to block the axial end portion of the flow path 60 for the second fluid, which will tend to generate the above stagnation of the second fluid to cause the boiling of the second fluid. Although FIG. 9 shows an example in which the folded structures 23 are formed on both end potion sides of the outer cylinder 20, the folded structure 23 may be formed on one end portion side of the outer cylinder 20.

The folded structure 23 can be produced by bending the outer cylinder 20. The type of bending is not particularly limited, and various known methods may be used.

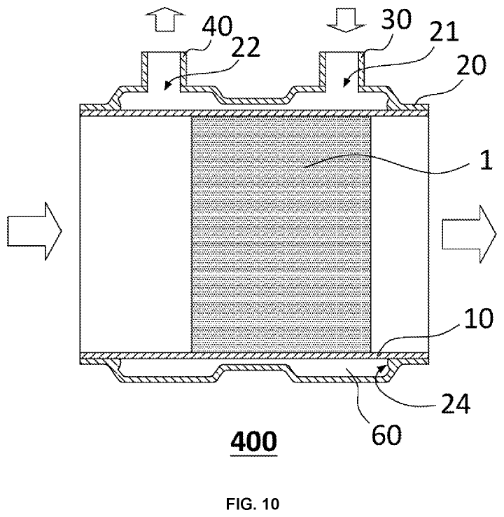

FIG. 10 is a cross-sectional view of other heat exchanger according to Embodiment 3 of the present invention, which is parallel to the flow direction of the first fluid.

As shown in FIG. 10, a heat exchanger 400 according to Embodiment 3 of the present invention includes: an inner cylinder 10; an outer cylinder 20; a feed pipe 30; and a discharge pipe 40. Moreover, the heat exchanger 400 has a welded bead portion 24 on at least one end portion side of the outer cylinder 20 as a flow path blockage-processed portion.

It should be noted that the components having the same reference numerals as those appearing in the description of the heat exchanger 100 according to Embodiment 1 of the present invention are the same as those of the other heat exchanger 400 according to Embodiment 3 of the present invention. Therefore, the descriptions thereof are omitted.

In the heat exchanger 400 according to Embodiment 3 of the present invention, the welded bead portion 24 is formed to block the axial end portion of the flow path 60 for the second fluid, which will tend to generate the above stagnation of the second fluid to cause the boiling of the second fluid. Although FIG. 10 shows an example in which the welded bead portions 24 are formed on both end portion sides of the outer cylinder 20, the welded bead portion 24 may be formed on one end portion side of the outer cylinder 20.

The welded bead portion 24 is a portion where the outer cylinder 20 is melted and solidified when the outer cylinder 20 is welded to the inner cylinder 10. The welding method is not particularly limited, and arc welding (e.g., TIG welding, MIG welding) or the like may be used.

Although not shown, the heat exchanger 300 according to Embodiment 3 of the present invention may include both the folded structure 23 and the welded bead portion 24 on at least one end portion side of the outer cylinder 20 as flow path blockage-processed portions. Such a structure can lead to stable suppression of the boiling of the second fluid due to the stagnation of the second fluid.

In the heat exchangers 300 and 400 according to Embodiment 3 of the present invention, the flow path blockage-processed portion (the folded structure 23 and/or the welded bead portion 24) as the boiling suppressing portion is formed in the outer cylinder 20 in the flow path 60 for the second fluid, so that effects of improving the heat recovery performance and of suppressing the erosion of the members forming the flow path 60 for the second fluid can improved.

### Embodiment 4

A heat exchanger according to Embodiment 4 of the present invention is different from the heat exchanger 100 according to Embodiment 1 of the present invention in that the former includes a diameter-decreased structural portion of the feed port 21 as a boiling suppressing portion.

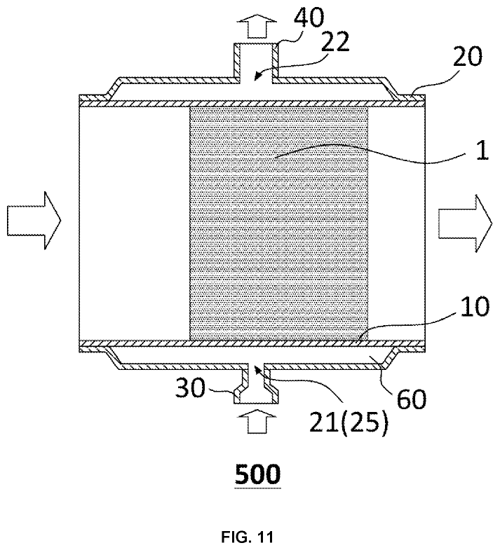

FIG. 11 is a cross-sectional view of the heat exchanger according to Embodiment 4 of the present invention, which is parallel to the flow direction of the first fluid.

As shown in FIG. 11, a heat exchanger 500 according to Embodiment 4 of the present invention includes: an inner cylinder 10; an outer cylinder 20; a feed pipe 30; and a discharge pipe 40. Further, the heat exchanger 500 has a diameter-decreased structural portion 25 of the feed port 21 as a flow path blockage-processed portion.

As used herein, the “diameter-decreased structural portion 25 of the feed port 21” means the feed port 21 or a structural portion around it, which is designed to decrease the diameter of the feed port 21.

It should be noted that the components having the same reference numerals as those appearing in the description of the heat exchanger 100 according to Embodiment 1 of the present invention are the same as those of the heat exchanger 500 according to Embodiment 4 of the present invention. Therefore, the descriptions thereof are omitted.

The flow of the second fluid may also slow down around the feed port 21 (a connected portion of the outer cylinder 20 to the feed pipe 30), although it depends on the shape of the flow path 60 for the second fluid. As a result, the second fluid also tends to stagnate around the feed port 21, and the temperature of the second fluid may continuously increase, causing the second fluid to boil. In such a state, the heat recovery performance is deteriorated, and the members around it (the outer cylinder 20 and the feed pipe 30) tend to be eroded.

Therefore, in the heat exchanger 500 according to Embodiment 4 of the present invention, the diameter-decreased structural portion 25 is provided at the feed port 21 which will tend to generate the above stagnate of the second fluid to cause the boiling of the second fluid, so that the flow rate of the second fluid flowing into the flow path 60 for the second fluid can be increased, and the stagnation of the second fluid can also be suppressed around the feed port 21.

FIG. 11 illustrates a case where the diameter of the feed port 21 is smaller than that of the discharge port 22 as the diameter-decreased structural portion 25, but the diameter of the feed port 21 may be the same as that of the discharge port 22, and a ring-shaped member (such as a washer) may be installed at the feed port 21 to decrease the diameter. Alternatively, the feed port 21 may be processed from the outside by machining or the like, such that the diameter of the feed port 21 is decreased.

The diameter-decreased structural portion 25 of the feed port 21 preferably has a diameter of 65 to 95% of the diameter of the discharge port 22. By setting the diameter of the feed port 21 to 95% or less of the diameter of the discharge port 22, the above effects can be stably obtained. Further, by setting the diameter of the feed port 21 to be 65% or more of the diameter of the discharge port 22, a decrease in pressure loss in the flow path 60 for the second fluid can be suppressed. In particular, when the diameter of the feed port 21 is less than 65% of the diameter of the discharge port 22, the second fluid tends to stagnate around the diameter-decreased structural portion 25 (back side of the connected portion).

It is preferable that in the heat exchanger 500 according to Embodiment 4 of the present invention, the feed port 21 and the discharge port 22 are provided at the axial central portion of the outer cylinder 20, and the feed pipe 30 and the discharge pipe 40 are connected to the feed port 21 and the discharge port 22, respectively. It is also preferable that the feed pipe 30 and the discharge pipe 40 extend in different directions. With such a structure, the effect of the diameter-decreased structural portion 25 of the feed port 21 can be stably obtained.

Since the heat exchanger 500 according to Embodiment 4 of the present invention includes the diameter-decreased structural portion 25 of the feed port 21 as the boiling suppressing portion, effects of improving the heat recovery performance and of suppressing erosion of the members forming the flow path 60 for the second fluid can be enhanced.

### Embodiment 5

A heat exchanger according to Embodiment 5 of the present invention is different from the heat exchanger 100 according to Embodiment 1 of the present invention in that the former includes a high-thermal resistant-processed portion as a boiling suppression portion in at least a part of the inner cylinder 10.

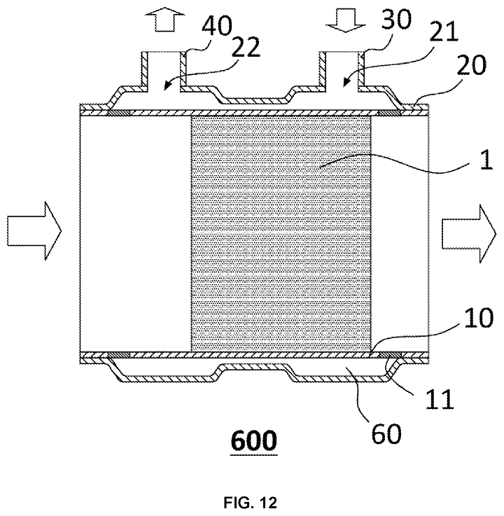

FIG. 12 is a cross-sectional view of the heat exchanger according to Embodiment 5 of the present invention, which is parallel to the circulation direction of the first fluid.

As shown in FIG. 12, a heat exchanger 600 according to Embodiment 5 of the present invention includes: an inner cylinder 10; an outer cylinder 20; a feed pipe 30; and a discharge pipe 40. Also, the heat exchanger 600 has a high-thermal resistant-processed portion 11 in at least a portion of the inner cylinder 10.

It should be noted that the components having the same reference numerals as those appearing in the description of the heat exchanger 100 according to Embodiment 1 of the present invention are the same as those of the heat exchanger 600 according to Embodiment 5 of the present invention. Therefore, the descriptions thereof are omitted.

As described in Embodiment 1, the flow of the second fluid may slow down around the axial end portions of the flow path 60 for the second fluid, although it depends on the shape of the flow path 60 for the second fluid. In this case, the second fluid tends to stagnate around the axial end portions of the flow path 60 for the second fluid, and the temperature of the second fluid may continuously increase, causing the second fluid to boil. In such a state, the heat recovery performance is deteriorated, and the members around it (the inner cylinder 10 and the outer cylinder 20) tend to be eroded.

Therefore, in the heat exchanger 600 of Embodiment 5 of the present invention, the high-thermal resistant-processed portion 11 is provided in the inner cylinder 10 facing the flow path 60 for the second fluid, which will tend to generate the above stagnation to cause the boiling of the second fluid. By providing the high-thermal resistant-processed portion 11, the heat of the first fluid is difficult to be transmitted to the surface of the high-thermal resistant-processed portion 11 on the flow path 60 side for the second fluid, so that it will be difficult for the second fluid to boil. Further, based on the flow path direction of the first fluid as a reference, it is possible to prevent the heat of the first fluid from being transmitted to the region of the inner cylinder 10 located on an upstream side of the heat recovery member 1, and the heat of the first fluid from being lowered before being collected by the heat recovery member 1. As a result, the heat recovery performance is improved by providing the high-thermal resistant-processed portion 11.

It should be noted that FIG. 12 shows an example in which the high-thermal resistant-processed portions 11 are formed on both end portion sides of the inner cylinder 10, but the high-thermal resistant-processed portion 11 may be formed on one end portion side of the inner cylinder 10.

As used herein, the high-thermal resistant-processed portion 11 means a portion of the inner cylinder 10 that has been processed so as to have a higher thermal resistance than that of the portion other than the high-thermal resistant-processed portion 11. More particularly, the thermal resistance of the high-thermal resistant-processed portion 11 is preferably 0.01 K/W or more, and more preferably 0.02 KNV or more.

The high-thermal resistant-processed portion 11 is preferably provided at a portion facing a length region of 50% or less of the maximum flow path height of the flow path 60 for the second fluid from the end portion of the flow path for the second fluid. Since the second fluid tends to stagnate in the flow path 60 for the second fluid facing such a region, that portion can be provided with the high-thermal resistant-processed portion 11, thereby stably suppressing the boiling of the second fluid.

Although the high-thermal resistant-processed portion 11 is not particularly limited, for example, the thickness of the portion forming the high-thermal resistant-processed portion 11 of the inner cylinder 10 may be made larger than the thickness of the other portions. Alternatively, the portion forming the high-thermal resistant-processed portion 11 may be formed of a material having a higher thermal resistance than the other portions. Specifically, impurities may be introduced into the portion of the inner cylinder 10 that will form the high-thermal resistant-processed portion 11, or the portion may be formed of a different material. Further, the portion of the inner cylinder 10 that will form the high-thermal resistant-processed portion 11 may be annealed so as to have a large number of crystal grain boundaries different from the other portions. Furthermore, a heat-resistant sheet may be attached to the surface of the portion of the inner cylinder 10 that will form the high-thermal resistant-processed portion 11, or a heat-resistant paint may be applied. Moreover, the portion of the inner cylinder 10 that will form the high-thermal resistant-processed portion 11 may be processed to have a multi-layered structure.

Since the heat exchanger 600 according to Embodiment 5 of the present invention includes the high-thermal resistant-processed portion 11 as a boiling suppressing portion in at least part of the inner cylinder 10, effects of improving the heat recovery performance and of suppressing the erosion of the members forming the flow path 60 for the second fluid can be enhanced.

### Embodiment 6

A heat exchanger according to Embodiment 6 of the present invention is different from the heat exchanger 100 according to Embodiment 1 of the present invention in that the former includes a smoothed surface portion as a boiling suppression portion in at least a portion of the inner cylinder 10.

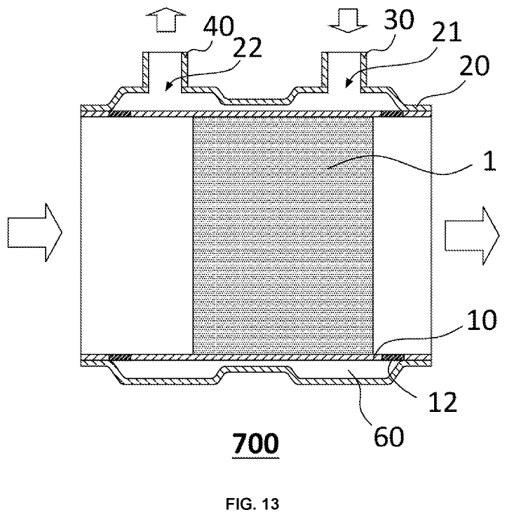

FIG. 13 is a cross-sectional view of the heat exchanger according to Embodiment 6 of the present invention, which is parallel to the flow direction of the first fluid.

As shown in FIG. 13, a heat exchanger 700 according to Embodiment 6 of the present invention includes: an inner cylinder 10; an outer cylinder 20; a feed pipe 30; and a discharge pipe 40. Moreover, the heat exchanger 700 has a smoothed surface portion 12 in at least a part of the inner cylinder 10.

It should be noted that the components having the same reference numerals as those appearing in the description of the heat exchanger 100 according to Embodiment 1 of the present invention are the same as those of the heat exchanger 700 according to Embodiment 6 of the present invention. Therefore, the descriptions thereof are omitted.

As described in Embodiment 1, the flow of the second fluid may slow down around the axial end portions of the flow path 60 for the second fluid, although it depends on the shape of the flow path 60 for the second fluid. In this case, the second fluid tends to stagnate around the axial end portions of the flow path 60 for the second fluid, and the temperature of the second fluid may continuously increase, causing the second fluid to boil. In such a state, the heat recovery performance is deteriorated, and the members around it (the inner cylinder 10 and the outer cylinder 20) tend to be eroded.

Therefore, in the heat exchanger 700 of Embodiment 6 of the present invention, the smoothed surface portion 12 is provided in the inner cylinder 10 facing the flow path 60 for the second fluid, which will tend to generate the above stagnation of the second fluid to cause the boiling of the second fluid. Since the heat transfer of the inner cylinder 10 decreases as the surface area of the inner cylinder 10 decreases, the provision of the smoothed surface portion 12 in this portion leads to a difficulty to transmit the heat of the first fluid to the surface of the smoothed surface portion 12 on the flow path 60 side for the second fluid, so that even if the second fluid stagnates, it is difficult for the second fluid to boil. Further, based on the flow path direction of the first fluid as a reference, it is also possible to prevent the heat of the first fluid from being transmitted to the region of the inner cylinder 10 located on the upstream side of the heat recovery member 1, and the heat of the first fluid from being lowered before being collected by the heat recovery member 1. As a result, heat recovery performance is improved by providing the smoothed surface portion 12.

It should be noted that FIG. 13 shows an example in which the smoothed surface portions 12 are formed on both end portion sides of the inner cylinder 10, but the smoothed surface portion 12 may be formed on one end portion side of the inner cylinder 10.

The smoothed portion 12 may preferably have a surface roughness Ra of 10 μm or less, although not particularly limited thereto. By controlling the surface roughness Ra to such a range, the boiling of the second fluid can be stably suppressed.

As used herein, the surface roughness Ra means an arithmetic mean roughness measured according to JIS B 0601:2013.

The smoothed surface portion 12 may be formed on either the inner surface or the outer surface of the inner cylinder 10, but the smoothed surface portions 12 may preferably be formed on both surfaces. The forming of the smoothed surface portions 12 on both surfaces of the inner cylinder 10 enhances the effect of suppressing the boiling of the second fluid.

It is preferable that the smoothed surface portion 12 is provided at a portion facing a length region of 50% or less of the maximum flow path height of the flow path 60 for the second fluid from the end portion of the flow path for the second fluid. Since the second fluid tends to stagnate in the flow path 60 for the second fluid facing such a region, the smoothed surface portion 12 can be provided in this portion to stably suppress the boiling of the second fluid.

The smoothed surface portion 12 can be formed by polishing the portion of the inner cylinder 10 that will form the smoothed surface portion 12. Polishing conditions and the like may be appropriately adjusted depending on the type of the inner cylinder 10, and they are not particularly limited.

Since the heat exchanger 700 according to Embodiment 6 of the present invention includes the smoothed surface portion 12 in at least a part of the inner cylinder 10 as the boiling suppressing portion, effects of improving the heat recovery performance and of suppressing erosion of the members forming the flow path 60 for the second fluid can be enhanced.

### DESCRIPTION OF REFERENCE NUMERALS

1 heat recovery member
2 downstream end portion
10 inner cylinder
11 high-thermal resistant-processed portion
12 smoothed surface portion
20 outer cylinder
21 feed port
22 discharge port
23 folded structure
24 weld bead portion
25 diameter-decreased structural portion
30 feed pipe
40 discharge pipe
50 flow path blocking member
60 flow path for second fluid
61a upstream end portion
61b downstream end portion
100, 200, 300, 400, 500, 600, 700 heat exchanger
210 first cylindrical member
220 second cylindrical member
230 first cylindrical connecting member
240 second cylindrical connecting member
250 third cylindrical member
260 on-off valve
270 sealing material
1000, 2000 honeycomb structure
1100 outer peripheral wall
1200 cell
1300 partition wall
1400 inner peripheral wall
C1, C2 axial central portion

1. A heat exchanger, comprising:
a heat recovery member through which a first fluid can flow;
an inner cylinder configured to house the heat recovery member;
an outer cylinder having a feed port capable of feeding a second fluid and a discharge port capable of discharging the second fluid, the outer cylinder being disposed on a radially outer side of the inner cylinder with a distance such that a flow path for the second fluid is formed between the outer cylinder and the inner cylinder;
a feed pipe connected to the feed port; and
a discharge pipe connected to the discharge port,
wherein, based on a flow path direction of the first fluid as a reference, the heat recovery member is arranged such that an axial central portion of the heat recovery member is located on a downstream side of an axial central portion of the inner cylinder, and a downstream end portion of the heat recovery member is located on an upstream side of a downstream end portion of the flow path for the second fluid.

2. The heat exchanger according to claim 1, wherein, based on the flow path direction of the first fluid as a reference, the downstream end portion of the heat recovery member is arranged on an upstream side by 10 mm or more away from the downstream end portion of the flow path for the second fluid.

3. The heat exchanger according to claim 1, wherein, based on the flow path direction of the first fluid as a reference, the downstream end portion of the heat recovery member is arranged on an upstream side away from the downstream end portion of the flow path for the second fluid by 10% or more of a length of the flow path for second fluid.

4. The heat exchanger according to claim 1, wherein a boiling suppressing portion for suppressing boiling of the second fluid is provided in the flow path for the second fluid.

5. The heat exchanger according to claim 4, wherein the boiling suppressing portion is one or more selected from: a flow path blocking member arranged to block at least a part of the flow path for the second fluid; a flow path blockage-processed portion of at least a part of the outer cylinder; a diameter-decreased structural portion of the feed port; a high-thermal resistant-processed portion of at least a part of the inner cylinder; and a smoothed surface portion of at least a part of the inner cylinder.

6. The heat exchanger according to claim 5, wherein the flow path blocking member is arranged to block at least one end portion of the flow path for the second fluid, and the flow path blocking member blocks a region from the end portion of the flow path for the second fluid to a length region of 50% or less of the maximum flow path height of the flow path for the second fluid.

7. The heat exchanger according to claim 6, wherein the flow path blocking member is a ring-shaped member.

8. The heat exchanger according to claim 5, wherein the flow path blockage-processed portion is a folded structure and/or a welded bead portion formed on at least one end portion side of the outer cylinder.

9. The heat exchanger according to claim 5, wherein the diameter-decreased structural portion of the feed port has a diameter of the feed port that is 65 to 95% of the diameter of the discharge port.

10. The heat exchanger according to claim 5, wherein the high-thermal resistant-processed portion is provided at a portion facing a length region of 50% or less of the maximum flow path height of the flow path for the second fluid from the end portion of the flow path for the second fluid.

11. The heat exchanger according to claim 10, wherein the high-thermal resistant-processed portion has a thermal resistance of 0.01 K/W or more.

12. The heat exchanger according to claim 5, wherein the smoothed surface portion has a surface roughness Ra of 10 μm or less.

13. The heat exchanger according to claim 12, wherein the smoothed surface portion is provided at a portion facing a length region of 50% or less of the maximum flow path height of the flow path for the second fluid from the end portion of the flow path for the second fluid.

14. The heat exchanger according to claim 1, wherein the heat recovery member is a honeycomb structure comprising: an outer peripheral wall; and a plurality of partition walls disposed on an inner side of the outer peripheral wall, the partition walls defining plurality of cells extending from a first end face to a second end face to form flow paths for a first fluid, or a honeycomb structure comprising: an outer peripheral wall; an inner peripheral wall; and a partition wall disposed between the outer peripheral wall and the inner peripheral wall, the partition wall defining a plurality of cells extending from a first end face to a second end face to form flow paths for a first fluid.
